(19) United States
(12) Patent Application Publication
(10) Pub. No.: US 2011/0106997 A1
(43) Pub. Date: May 5, 2011

(54) METHODS AND APPARATUS FOR INTERCONNECTING SAS/SATA DEVICES USING EITHER ELECTRICAL OR OPTICAL TRANSCEIVERS

(75) Inventors: Gabriel L. Romero, Colorado Springs, CO (US); Coralyn S. Gauvin, Manitou Springs, CO (US)

(73) Assignee: LSI CORPORATION, Milpitas, CA (US)

(21) Appl. No.: 12/613,456

(22) Filed: Nov. 5, 2009

(51) Int. Cl. G06F 13/00

(52) U.S. Cl. 710/300

(57) ABSTRACT

Methods and apparatus for interconnecting Serial Attached SCSI (SAS) or Serial Advanced Technology Attachment (SATA) devices using either an electrical communication medium or an optical communication medium. Each device includes an out of band (OOB) encoder/decoder (endec) logic component to translate between standard OOB signals used by the devices and digitally encoded OOB signals exchanged over the communication medium. Thus the devices may be coupled using either optical or electrical cabling. The digitally encoded OOB signals may also be scrambled to reduce electromagnetic interference (EMI) generated during OOB communications using the digitally encoded OOB signals. The scrambled digitally encoded OOB signals may comprise information regarding capabilities of the device that generated the underlying OOB signal. Such information may indicate to the other high speed device certain capabilities of the transmitting device—the information to be used in establishing logical connections between devices.

### RELATED PATENTS

This patent is related to commonly owned U.S. patent application Ser. No. 12/470,704 entitled METHODS AND APPARATUS FOR INTERCONNECTING SAS DEVICES USING EITHER ELECTRICAL OR OPTICAL TRANSCEIVERS which is hereby incorporated by reference.

### BACKGROUND

1. Field of the Invention

The invention relates generally to Serial Attached SCSI (SAS) and Serial Advanced Technology Attachment (SATA) device interconnections and more specifically relates to methods and apparatus for using either electrical or optical transceivers for such high speed serial device interconnections.

2. Discussion of Related Art

SAS and SATA standards include a detailed specification of the electrical interconnect utilized between two SAS/SATA devices (collectively referred to herein as “high speed serial devices”). Electrical signaling standards are defined for a variety of transmission rates between devices including, at present, up to 6 GB per second data signaling. Further enhancements to SAS/SATA specifications envision 12 GB or higher speed in the relatively near future.

In the SAS/SATA signaling standards, out of band (OOB) signals are low-speed electrical signal patterns that do not appear in normal data streams. OOB signals consist of a defined amount of idle time followed by a defined amount of burst time, the idle-burst pair repeated a specified number of times, and ending with a period of idle time. In accordance with the SAS/SATA standards, in the idle period of the OOB signal the electrical interconnection physical link carries a D.C. idle level-i.e., a differential 0V signal where the positive and negative differential signal paths are both driven toward ground potential. During the burst time of the OOB signal the differential electrical physical link carries signal transitions represented as differential voltages driven on the positive and negative signal paths between the transceiver transmission transceiver and the receiving transceiver—thus presenting a level of energy to be received by the other side.

A variety of OOB signals are differentiated based on the duration of the idle time between the various burst times and other timing aspects of the idle and burst signaling periods. SAS and SATA specifications include a variety of such OOB signals including, for example, COMSAS, COMINIT, COMRESET, and, COMWAKE. These OOB signals and other OOB conditions are used, for example, in SAS speed negotiations whereby two interconnected devices negotiate to determine the preferred speed at which the two devices may communicate over a physical link.

Despite the use of differential electrical signaling in accordance with the SAS/SATA specifications, as the transmission rates increase, cable length for the electrical signaling is limited. For example, at relatively high transmission speeds electrical signaling cables may be limited to no more than a few meters of total length to avoid degradation of the signal quality.

Fiber-optic signaling capabilities are known to provide both high speed transmission and noise immunity over significant lengths of optical transmission media. However, in view of the requirements in the SAS/SATA standard for OOB signaling, it has been problematic to effectively utilize fiber-optic signaling for interconnection of SAS/SATA devices. In particular, current SFP (small form-factor pluggable) optical transceivers (including widely utilized quad small form-factor pluggable—QSFP) are incapable of utilizing present SAS/SATA standards for electrical OOB signaling. In particular, there is no optical midpoint signal (i.e., no equivalent to an electrical “D.C. idle” signal available in such SFP optical transceiver modules). In other words there is no equivalent signaling capability in SFP optical transceivers to represent an OOB idle time.

Some prior solutions have attempted to provide OOB signaling for SAS/SATA interconnect utilizing optical transceiver modules by encoding an idle time as the period of time that an optical laser is turned off (i.e., an optical laser off duration represents some analogous idle time duration in accordance with the SAS/SATA specifications). This prior technique presents other problems—the turn-on/turn-off time of high speed, low cost, SFP optical modules is several orders of magnitude slower than the timing requirements for OOB signaling in accordance with the SAS and SATA specifications. Further, problems arise in the receiving transceiver sensing loss of optical signal. The receiving transceiver sensing of a loss of optical signaling (RXlos) may impose further significant delays and distortion in the timing such that the desired OOB transmission may be corrupted.

Thus it is an ongoing challenge to provide simple, cost-effective, high-speed optical signaling between SAS/SATA devices that permit full compliance with the SAS/SATA standard including the OOB signaling capabilities.

### SUMMARY

The present invention solves the above and other problems, thereby advancing the state of the useful arts, by providing methods, apparatus, and systems for utilizing digital encoding of SAS/SATA OOB signals to enable use of optical communication media for coupling SAS/SATA devices. Features and aspects hereof permit devices to optionally use either standard SAS/SATA electrical signaling over electrical communication media or digitally encoded OOB signaling to permit use of either electrical or optical communication media. The above cited related application (U.S. patent application Ser. No. 12/470,704—incorporated by reference) provides various embodiments for a similar technology. This patent application provides various enhancements and improvements to the invention claimed in the related application.

In one aspect hereof, apparatus is provided associated with a first high speed serial device for coupling with another high speed serial device using an optical communication medium or using an electrical communication medium, Both the first and second high speed serial devices are either Serial Attached SCSI (SAS) devices or Serial Advanced Technology Attachment (SATA) devices. The apparatus includes PHY control circuits coupled with a communication interface and adapted to control data exchanges on the communication medium. The apparatus further includes digital out of band (OOB) encoder/decoder (endec) logic coupled with the PHY control circuits and coupled with the communication medium. The digital OOB endec logic adapted to translate between OOB signals utilized by the PHY control circuits and digitally encoded OOB signals utilized on the communication medium. The apparatus further includes scrambling logic coupled with the digital OOB endec to de-scramble digitally encoded OOB signals received from the communication medium and to scramble generated digitally encoded OOB signals generated by the digital OOB endec for application to the communication medium.

Another aspect hereof provides a method operable in a system that comprises apparatus associated with a high speed serial device. The high speed serial device is either a Serial Attached SCSI (SAS) device or a Serial Advanced Technology Attachment (SATA) device. The method includes receiving over a communication medium coupled with the apparatus a digitally encoded signal from another high speed serial device. The method then descrambles the digitally encoded signal and decodes the received descrambled digitally encoded signal to generate a signal representing an incoming out of band (OOB) signal. The method then applies the generated signal to a PHY logic circuit within the high speed serial device. The generated OOB signal is then processed within the high speed serial device as though the incoming OOB signal had been received in the PHY logic circuit from the communication medium.

Still another aspect hereof provides system that includes a first high speed serial device and a second high speed serial device. Both the first and second high speed devices are either Serial Attached SCSI (SAS) devices or Serial Advanced Technology Attachment (SATA) devices. The system also includes a communication medium coupled the first high speed serial device with the second high speed serial device. The system further includes a first digital out of band (OOB) encoder/decoder (endec) logic coupled with the first high speed serial device and coupled with the communication medium. The first digital OOB endec logic adapted to translate between OOB signals utilized by the first SAS device and digitally encoded OOB signals utilized on the communication medium. The system also includes a first scrambling logic coupled with the first digital OOB endec. The first scrambling logic operable to de-scramble digitally encoded OOB signals received from the communication medium and further operable to scramble digitally encoded OOB signals generated by the first digital OOB endec for application to the communication medium. The system further includes a second digital out of band (OOB) encoder/decoder (endec) logic coupled with the second high speed serial device and coupled with the communication medium. The second digital OOB endec logic adapted to translate between OOB signals utilized by the second high speed serial device and digitally encoded OOB signals utilized on the communication medium. The system also includes a second scrambling logic coupled with the second digital OOB endec. The second scrambling logic operable to de-scramble digitally encoded OOB signals received from the communication medium and further operable to scramble digitally encoded OOB signals generated by the second digital OOB endec for application to the communication medium.

### BRIEF DESCRIPTION OF THE DRAWINGS

FIG. 1 is a block diagram of exemplary high speed serial devices enhanced in accordance with features and aspects hereof to provide optional digital encoding of OOB signals for exchange over optical or electrical communication media.

FIG. 2 is a block diagram of an exemplary PHY logic circuit enhanced in accordance with features and aspects hereof to provide optional digital encoding of OOB signals for exchange over optical or electrical communication media.

FIGS. 3 through 6 are flowcharts describing exemplary methods in accordance with features and aspects hereof to provide optional digital encoding of OOB signals for exchange over optical or electrical communication media.

FIG. 7 is a block diagram showing an exemplary embodiment of enhanced logic for receiving digitally encoded OOB signals where the enhanced logic is substantially external to the circuits of the high speed device.

### DETAILED DESCRIPTION OF THE DRAWINGS

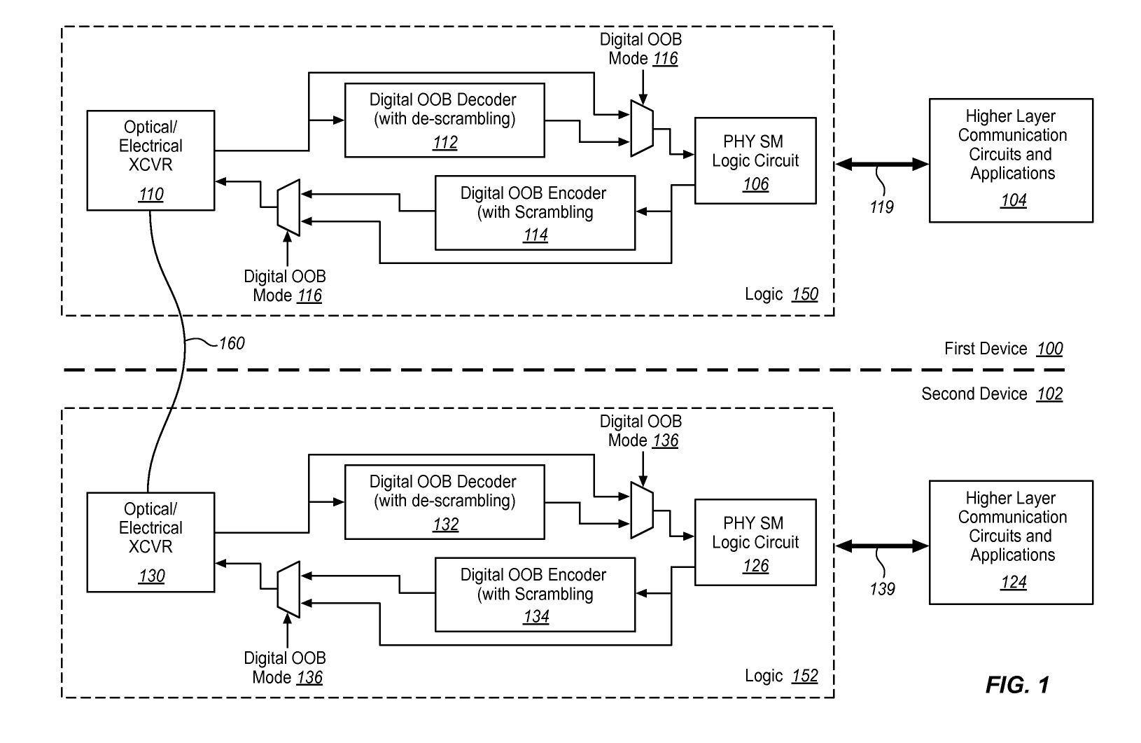

FIG. 1 is a block diagram of a system including a first high speed serial device 100 coupled with a second high speed serial device 102. In one embodiment the system may comprise a SAS domain such that each device (100 and 102) may be a SAS compliant device. In another embodiment, the devices (100 and 102) may be SATA compliant devices. The discussion that follows will focus primarily on a SAS embodiment but those of ordinary skill in the art readily understand that the features discussed may be equally applied in a SATA environment as well as other high speed serial applications. The exemplary interconnections of components in FIG. 1 are intended to represent functional modules and relationships within the devices 100 and 102 and not necessarily any particular circuit implementation or design.

Each of first high speed serial device 100 and second high speed serial device 102 is enhanced in accordance with features and aspects hereof to enable digital encoding and decoding of OOB signals transferred between the two devices. By digitally encoding OOB signals, SAS/SATA communications utilizing an optical communication medium 160 is possible. As noted above, without the enhanced features and aspects hereof within first device 100 and second device 102, optical communication media has presented significant challenges for OOB signaling.

First device 100 includes logic 150 enhanced in accordance with features and aspects hereof to include logic for digitally encoding OOB information and decoding received digital information representing an encoded OOB signal. Logic 150 is coupled via path 119 with higher layer communications circuits and applications 104 directing logic 150 to exchange information with the second device 102. In like manner, second device 102 includes enhanced logic 152 coupled via path 139 to higher layer communications circuits and applications 124.

Enhanced logic 150 includes PHY state machine (SM) control circuit 106 essentially providing standard features of the PHY control as defined by the SAS specifications. Such PHY SM control logic 106 is generally defined in the SAS (and SATA) specifications as a state machine operable to encode and decode information exchanged over the communication medium such as communication medium 160. As is generally known in present SAS/SATA devices, logic 150 may include an electrical serializer/deserializer (commonly referred to as SerDes or transceiver) 110 coupled with PHY SM control circuit 106 (when multiplexers 116 are properly configured) for transmitting and receiving modulated signals during the exchange of normal data (i.e., not OOB signals). In accordance with features and aspects hereof, transceiver 110 may be either an electrical transceiver (i.e., modulating differential voltage electrical signals) over an electrical communication medium 160 or may be a optical transceiver modulating optical signals on an optical communication medium 160 for exchange of information between first device 100 and second device 102.

Enhanced logic 150 may include digital OOB decoder logic 112 and digital OOB encoder 114 (collectively referred to as an encoder/decoder or simply “endec”). Decoder logic 112 may include de-scrambling logic to descramble sequences of dwords representing a digitally encoded OOB signal received from the communication medium 160 via transceiver 110. In like manner encoder logic 114 may include scramble logic for scrambling sequences of dwords generated to transmit a digitally encoded OOB signal. The scrambling of transmitted dwords helps prevent electromagnetic interference generated from repeating patterns of dwords transmitted on an electrical communication medium. Scrambling techniques are well known to those of ordinary skill in the art as specified in SAS specifications (e.g., as defined in link layer specification in section 7.6 of the SAS standards) as well as the SATA standards (e.g., as defined in section 9.5 of the SATA standards). As a matter of design choice, the scrambling and de-scrambling logic components may be implemented as logic components integral with the enhanced features of the endec as presented in FIG. 1 or may be shared with logic components of other layers of the SAS device (such as the link layer logic within module 104).

The endec (112 and 114- and associated scrambling logic) are arranged in conjunction with digital OOB mode multiplexors 116 to selectively switch so as to couple between PHY SM logic circuit and SerDes 110. In a first configuration of multiplexers 116 where digital encoding of OOB signals is not required, PHY SM logic circuit 106 is directly coupled with SerDes 110 in a manner to provide standard electrical signaling of both “normal” data and OOB signals between device 100 and device 102. This standard electrical signaling includes standard OOB signaling relying on D.C. Idle signals and so called burst signals applied to electrical communication medium 160.

In a second configuration of multiplexers 116 when digital encoding of OOB signals is desired and presently required/allowed, digital OOB decoder 112 and digital OOB encoder 114 along with de-scrambling logic 108 and scrambling logic 118 are interposed between PHY SM logic circuit 106 and SerDes 110 and are operable to sense (de-scramble and decode) and generate (encode and scramble), respectively, a digitally encoded signal representing an OOB signal exchanged between devices 100 and 102. Such a digitally encoded signal may be applied to optical communication path 160 through transceiver 110 for exchange between the first SAS device 100 and the second SAS device 102. In addition, the digitally encoded OOB signals may be exchanged over an electrical communication medium 160 through a suitable SerDes 110. Digital OOB decoder 112 is operable to receive a digitally encoded signal through SerDes 110 from communication path 160 and decode the received digitally encoded signal to generate a corresponding OOB signal for application to PHY SM logic circuit 106. Digital OOB encoder 114 is operable to generate a digitally encoded OOB signal in response to signals from PHY SM logic circuit 106 and to apply the generated digitally encoded OOB signals to SerDes 110 for application to a communication medium and forwarding to the second SAS device 102. It will be understood that when digital encoding of OOB signals is desired but not presently required/allowed, multiplexers 116 are configured as described above to couple PHY SM logic 106 to couple with transceiver 110 for the exchange of “normal data” (i.e., non-OOB signals).

Those of ordinary skill in the art will readily recognize that the OOB decoder 112 and encoder 114 may be implemented as circuits physically interposed (with appropriate multiplexer switching logic) distinct from and between PHY SM logic circuit 106 and SerDes 110 as illustrated in FIG. 1. Alternatively, the decoder and encoder (112 and 114) may be integrated within the PHY SM logic circuit 106 or within the electrical SerDes 110. Still further, the features of decoder 112 and encoder 114 may be integrated within active components physically integrated in the connector of a cable (e.g., communication medium 160) that couples devices 100 and 102 rather than within the logic that comprises the devices 100 and 102. In like manner, SerDes 110 and 130 may be integral within logic 150 and 152, respectively, or may be separate components.

As noted herein, it will be recognized that the digital encoding and decoding of OOB signals may be utilized regardless of the particular type of communication medium employed (electrical or optical) whereas standard OOB analog signaling cannot be used on optical communication media without significant challenges as discussed in the Background section above. Though such digital encoding of OOB signals is not required on an electrical communication medium, features and aspects hereof for such digital encoding of OOB may be utilized on such a communication medium as well as on an optical communication medium.

Enhanced logic 152 in second SAS device 102 is essentially identical to logic 150 in first SAS device 100. In particular, PHY SM logic circuit 126 communicates with higher layer communication circuits and applications 124 via path 139. Circuit 126 then communicates with electrical SerDes 130 directly in one configuration of multiplexers 136. Digital OOB decoder 132 and digital OOB encoder 134 may be interposed between circuits 126 and 128 in a second configuration of multiplexers 136. An optional optical transceiver 130 may also be provided to allow optical communication of SAS exchanges including digitally encoded OOB signals.

Those of ordinary skill in the art will readily recognize that each SAS device (100 and 102) may represent any of a number of types of SAS devices including, for example, a SAS initiator, a SAS target, or a SAS expander. Further, those of ordinary skill in the art will readily recognize that the enhanced features and aspects hereof may be implemented as integral within logic circuits 150 and 152, may be external to the PHY logic (i.e., within an active cable connector), or any other suitable integration within the enhanced SAS device. These and other design choices will be readily apparent to those of ordinary skill in the art for implementation of the enhanced features and aspects hereof.

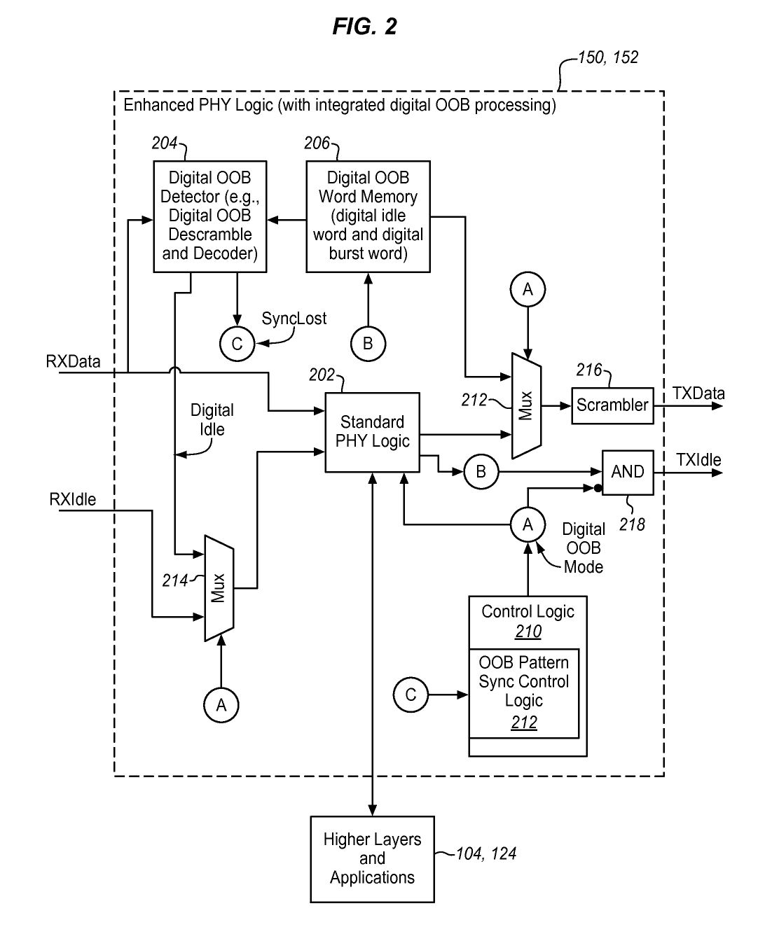

FIG. 2 is a block diagram providing exemplary additional details of enhanced PHY logic 150 and 152 of FIG. 1. Specifically, FIG. 2 shows the digital OOB decoding and encoding logic in an exemplary embodiment as combined with the standard PHY logic (e.g., the PHY SM logic circuits as discussed in FIG. 1). Enhanced PHY logic 150 and 152 may include standardized PHY logic 202 operable generally in accordance with the state machine model specified in the SAS standards. Implementation details of such a standard PHY logic component are well known to those of ordinary skill in the art and documented in the SAS standards as state machine descriptions and thus need not be further presented herein.

Control logic 210 of the enhanced PHY logic generates a Digital OOB Mode signal (label “A”) when the digital mode of SAS OOB processing is selected (e.g., for use with optical communication medium). This digital mode of operation may be selected by an administrative user/process (not shown) interacting with the control logic 210 to configure the digital mode of OOB processing or the standard electrical mode specified by the SAS standards.

In general, standard PHY logic 202 receives an RXData signal from a SerDes circuit (not shown in FIG. 2) coupled to the communication medium (either an optical or electrical communication medium). The RXData signal is also applied to a digital OOB detector 204 for detecting/decoding a digitally encoded SAS OOB signal that may be received on the RXData signal path from another SAS device enhanced in accordance with features and aspects hereof. An RXIdle signal from the SerDes indicates detection of a D.C. idle condition when the SerDes circuit is coupled to an electrical communication medium utilizing the SAS standard OOB idle signaling for SAS OOB conditions. In a standard SAS electrical connection, such an RXIdle signal is asserted for the duration of the D.C. idle condition sensed on the electrical communication medium by the SerDes. In such a standard electrical connection, an idle period is followed by a burst condition on the electrical communication medium. These pairs of idle and burst periods on the electrical communication medium are repeated as per the SAS standards. The number and duration of the various idle and burst conditions represents different SAS OOB signals as specified by the SAS standards.

Where digital encoding of OOB signals is enabled in accordance with features and aspects hereof, a Digital Idle signal is asserted by the digital OOB detector 204 when a digitally encoded idle dword is sensed by digital OOB detector 204 from the data received on RXData from the SerDes. Detector 204 may include de-scrambling logic as described above in FIG. 1 to de-scramble sequences of digitally encoded OOB signals. The Digital Idle signal is cleared when a digitally encoded burst dword is first detected as received on the RXData signal (as descrambled) from the other SAS device. Multiple digitally encoded idle and burst dwords may be transmitted from the other SAS device to provide the desired number and duration of the idle and burst conditions to represent the various SAS OOB signals.

Other SAS encoded dwords (potentially also scrambled) may be received in between the one or more idle dwords and the one or more burst dwords. In particular, these other dwords may convey information regarding the device that transmitted the digitally encoded OOB signals. For example, the information may comprise indicators of compatibility levels of the transmitting device. Examples of such compatibility level information may include (among other features):
SAS generation 1 compatibility (supporting 1.5 and 3.0 Gbps),
SAS generation 2 compatibility (supporting 1.5, 3.0, and 6.0 Gbps),
SAS generation 3 compatibility (supporting 1.5, 3.0, 6.0, and 12.0 Gbps),
Serial Advanced Technology Attachment (SATA) compatibility,
vendor specific protocol compatibility, or
vendor specific device identification indicia.

In other embodiments, the dwords inserted between a digitally encoded idle dword and a digitally encoded burst dword may simply be ignored. In still other embodiments, the idle and burst digitally encoded dwords themselves may be selected from a plurality of possible dwords to represent particular features or capabilities of the transmitting device. For example, a transmitting device may encode an idle dword as D10.1 to indicate it is a “Gen 1” SAS device, as a D10.2 to indicate that it is a “Gen 2” SAS device, etc. In like manner the digitally encoded burst dword may be encoded as one of a plurality of possible dwords to indicate the features and capabilities of the transmitting device. Where a plurality of dwords may be used to encode the digital idle and burst signals, memory 206 (discussed further below) may store all such possible encodings.

The RXIdle signal from the SerDes (representing sensing of a D.C.

idle) and the Digital Idle signal from the digital OOB detector 204 are applied as inputs to multiplexer 214. The output of multiplexer 214 is controlled by the Digital OOB Mode signal (label “A”) generated by the control logic 210. The Digital Idle signal is selected as output of multiplexer 214 when the Digital OOB Mode signal is asserted and the RXIdle signal is selected for output from multiplexer 214 otherwise. The selected signal indicating detection of an idle condition is applied to the standard PHY logic 202 invoking standard processing within the PHY state machine of logic 202 in response to detection of the idle condition (and corresponding burst conditions following each idle condition as specified by SAS standards).

In the context of the digital OOB operation as controlled by control logic 210, digital OOB detector 204 detects receipt of a digitally encoded signal representing a SAS OOB idle condition in the communication medium. Such a digitally encoded signal may be applied to either an optical or electrical communication medium from another SAS device similarly enhanced in accordance with features and aspects hereof to utilize digitally encoded OOB signals to represent SAS OOB conditions. Digital OOB detector 204 utilizes the digital OOB dword memory 206 to retrieve an appropriately encoded (for disparity) idle dword that represents the digitally encoded signal representing the idle dword in the digital OOB encoding structures.

The digitally encoded dwords stored in memory 206 may be stored in both possible forms of disparity as is provided by the 8b10b encoding used in SAS and SATA protocols. Thus the appropriate disparity version may be selected to detect receipt in digital OOB detector 204 to detect receipt of a digitally encoded idle dword or a digitally encoded burst dword. Further, as noted above, a plurality of possible encodings of the idle and burst dwords may be stored in memory 206. Each of the possible encodings indicates a corresponding feature or capability of the device that encoded the transmitted idle or burst dwords.

Standard PHY logic 202 communicates all received SAS data to a higher level of SAS layers and applications 104 or 124 as discussed above. In addition, information to be transmitted to another SAS device is received by standard PHY logic 202 from the higher SAS layers and applications 104 or 124. Under control of control logic 210, standard PHY logic 202 generates transmit data output signals (TXData) applied as an input to multiplexer 212. Standard PHY logic 202 also generates a TXIdle signal (label “B”) indicating the need to transmit a D.C. Idle condition. In normal SAS/SATA operation without the enhancements of the present invention. both TXData and TXIdle are applied directly to the SerDes for modulation using electrical signals to transmit SAS data and SAS OOB signals. In accordance with embodiments of the present invention, the TXIdle signal is also applied to digital OOB memory 206 to select either a digitally encoded idle dword (when TXIdle is asserted) or a digitally encoded burst dword (when TXIdle is not asserted) for application as a second input to multiplexer 212. Where multiple dwords may be selected (i.e., proper disparity and/or encoding features of the device) control logic 210 may apply further signals (not shown) to memory 206 to determine which idle/burst dword to be selected.

Multiplexer 212 under control of control logic 210 generating the Digital OOB Mode signal (label “A”) then selects either the transmit data output of standard PHY logic 202 (TXData) or a selected digital OOB dword from memory 206 for application to the TXData output of enhanced PHY logic 150 or 152. The TXData signal so generated is then applied to a SerDes circuit (not shown) for modulation on the desired communication medium. When the digital OOB mode is selected (label “A”) the TXIdle signal (label “B”) is precluded from being applied to the SerDes by and gate 218. When digital OOB mode is not selected, the TXIdle signal from standard PHY logic 202 is applied normally to the SerDes to force generation of a standard D.C. idle condition on an electrical communication medium.

Other standard transmitted SAS data (e.g., non-OOB SAS data) is generated by standard PHY logic 202 and applied to the TXData output through an appropriate selection of multiplexer 212 by control logic 210. The digitally encoded signals representing a SAS OOB condition and the standard generated SAS data from standard PHY logic 202 may thus be applied to the TXData signal and modulated by an appropriate SerDes circuit onto the desired communication medium—either optical or electrical.

As noted above, the digitally encoded OOB dwords (idle and burst dwords) stored in memory 206 may be stored in both forms of disparity as defined by SAS 8b10b encoding standards for appropriate selection and application to the TXData signal path. The digitally encoded dwords stored in the memory 206 may be programmed by an administrative user through the control logic 210 or may be statically defined at time of manufacture of the SAS device embodying the enhanced PHY logic 150 or 152.

Those of ordinary skill in the art will readily recognize numerous additional and equivalent features and modules within fully functional enhanced PHY logic circuits 150 or 152 as depicted in FIGS. 1 and 2 described above. Such additional and equivalent elements are omitted herein for simplicity and brevity of this discussion but will be readily apparent to those of ordinary skill in the art. The specific signals utilized for any particular embodiment will depend on the signals available in an existing design of standard PHY logic 202 and the accompanying SerDes. Those of ordinary skill in the art will readily recognize which signals may be used from an existing PHY layer and SerDes to allow integration with the enhanced digital OOB features and aspects hereof. Further, those of ordinary skill in the art will readily recognize that the enhanced digital OOB features and aspects hereof may be integrated within the PHY logic as shown in FIGS. 1 and 2 and/or may be integrated within other levels and layers of circuitry associated with an enhanced first and second SAS device. Such design choices will be readily apparent to those of ordinary skill in the art. Still further, those of ordinary skill in the art will readily recognize numerous, well known, commercially available circuits for the desired SerDes capability including, for example, the GigaBlaze® circuit from LSI Corporation.

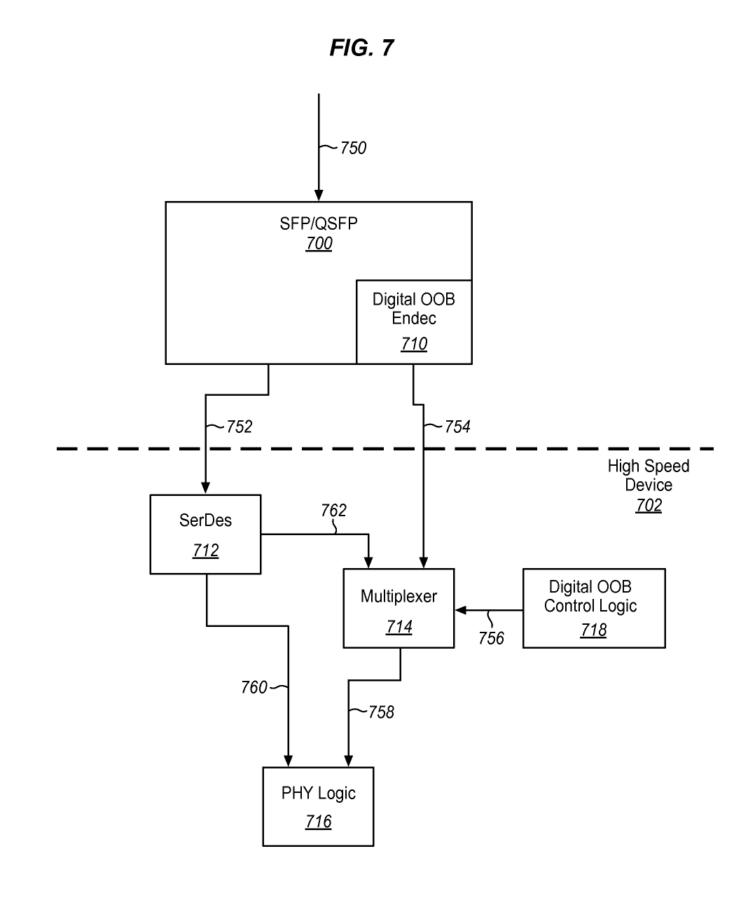

As noted above, the enhanced logic features of the present invention may be implemented as integrated with the PHY logic (as indicated generally in FIGS. 1 and 2) or may be implemented external to the PHY logic and even external to the SAS/SATA device that provides the PHY and other layers of communication logic. FIG. 7 is a block diagram of an exemplary embodiment of the enhanced features hereof where the enhanced logic is external to the SAS device. For example, the enhanced logic may reside in active components associated with the cabling SFP/QSFP connector coupling an optical communication medium to the device. Present day SFP and QSFP device such as those commercially available from Luxtera, Molex, and Tyco may include a secondary communication channel such as an Inter IC (I²C) serial communication bus for control/configuration communication exchanges. The I²C communication bus is well known to those of ordinary skill in the art and is publicly documented at, for example, www.i2c-bus.org. In other exemplary embodiments, the SFP/QSFP may include connector a general purpose I/O (GPIO) signal path distinct from the serial communication medium. Many SAS/SATA devices implementing PHY and/or Link layer control (such as the GigaBlaze® circuit from LSI Corporation) also include an I²C coupling and/or a GPIO signal path distinct from their coupling with the high speed serial communication medium. In such a configuration, the enhanced logic discussed above with respect to FIGS. 1 and 2 may be implemented external to the SAS device and may communicate with the SAS device communication circuits through this I²C and/or GPIO signaling path.

In FIG. 7 a high speed device (e.g., SAS/SATA device) is coupled with an SFP/QSFP 700 to permit data exchanged on an optical communication medium 750 to be translated into electrical signals exchanged with the device 702 via electrical communication medium 752. SerDes 712 within the device 702 receives electrical signals representing dwords to be applied to PHY logic 716 via path 760. In accordance with normal operation of device 702, SerDes 712 is also adapted to sense loss of the received signal (indicating an analog D.C. idle condition) and to so indicate the idle condition with a signal applied to path 762. SFP/QSFP 700 includes digital OOB endec 710 to sense receipt of a digitally encoded OOB signal and to indicate the detection via a signal applied to signal path 754. As noted above, signal path 754 may be implemented using standard features of commercially available SFP/QSFP modules including, for example, an I²C bus and/or a GPIO signal path. Device 102 has a similar communication interface capability to receive the signal on path 754. Where the digital OOB endec 710 is intended only to signal detection of a digitally encoded OOB signal, a simple GPIO signal path may be utilized for path 754 to simply indicate the analog equivalent of a D.C. idle condition for use within high speed device 702 (i.e., the “RXlos” signal in the GigaBlaze® circuit from LSI Corporation). In a preferred embodiment where a rich exchange is desired between the SFP/QSFP and the SAS device, path 754 includes an I²C communication link used in combination with a GPIO signaling structure. The richness of such exchanges may include, for example, programmably sharing the digitally encoded OOB dwords to be used for both generation and detection of digitally encoded OOB signals as well as a variety of signals sent to the SAS device indicating which of a variety of digitally encoded OOB dwords were detected.

The OOB signals on path 762 and signal path 754 are applied as inputs to multiplexer 714 and digital OOB control logic 718 selects via a signal on path 756 one of the inputs on multiplexer 714 for application to path 758 indicating to PHY logic 716 the sensing of an OOB signal. Those of ordinary skill in the art will recognize that FIG. 7 broadly depicts signals and paths used to sense digitally encoded OOB signals from another device. Similar logic and other signals on path 754 may be used to distinguish which of multiple digitally encoded OOB dwords were sensed. Those of ordinary skill in the art will further recognize similar logic to use signal path 754 between the high speed device 702 and the digital OOB endec 710 within SFP/QSFP 700 to force transmission of digitally encoded OOB dwords to another device. Related active circuits may be similarly embodied in connectors of electrical cables used to couple high speed devices such that the digitally encoded OOB signaling may be applied to electrical communication media.

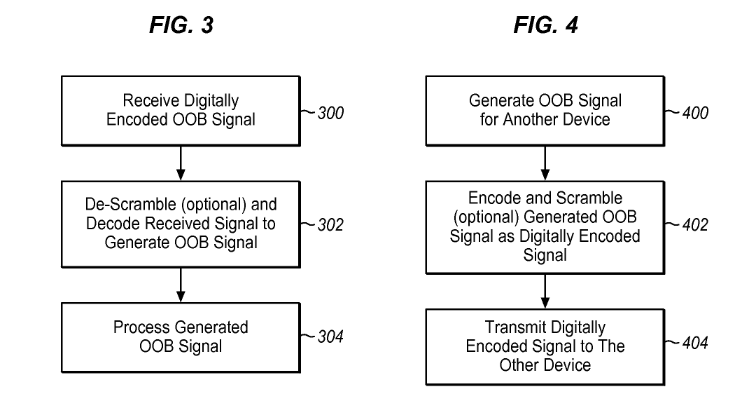

FIGS. 3 and 4 are flowcharts representing exemplary methods in accordance with features and aspects hereof to use digitally encoded signals for OOB communications. The exemplary methods of FIGS. 3 and 4 may be generally operable in an enhanced high speed device such as depicted in FIGS. 1 and 2 described above. As noted above, the enhanced features of the methods of FIGS. 3 and 4 may be implemented within an enhanced PHY logic circuit of an enhanced high speed device or within other circuits or logic implemented within the enhanced device. Still further, the methods of FIGS. 3 and 4 may be operable within enhanced circuitry and logic external to the high speed device suitably implemented as a plug-on card or daughter-board logic adapted to couple with an unenhanced SAS device. For example, the enhanced logic may be implemented in active circuits associated with a cable/connector coupling the devices (e.g., within a SFP/QSFP coupling the devices using an optical communication medium). In such an external embodiment, those of ordinary skill in the art will readily recognize as a matter of design choice the need to expose signals used within the PHY layer and/or SerDes circuits for use within the external enhanced circuit features to supply digital encoding and decoding of OOB signals. Such exposed signals may be exchanged using, for example, GPIO signals paths and/or I²C communication bus structures between the high speed device and the enhanced logic circuits.

The exemplary method of FIG. 3 represents processing within the enhanced device for receiving digitally encoded OOB signals on a communication medium representing associated analog OOB signals. As noted above, digitally encoded OOB information may be transmitted and received on an optical communication medium as well as an electrical communication medium. An electrical communication medium may also be adapted for standard OOB analog signaling thus allowing the enhanced device to be coupled with non-enhanced high speed devices.

Step 300 represents receipt of a digitally encoded OOB signal on the communication medium (e.g., from an optical or electrical communication medium). Step 302 de-scrambles (if necessary) and decodes the received signal to generate the corresponding OOB signal for further utilization within the enhanced device. As noted above and in accordance with the SAS/SATA standards, decoding of a particular OOB signal is performed by sensing the duration of idle and burst conditions received from another SAS device. Where digital OOB encoding/decoding features and aspects hereof are employed, the duration of an idle or burst condition is determined by the number of digitally encoded idle dwords and digitally encoded burst dwords (and hence the duration of each condition). Step 304 then processes the generated OOB signal within the enhanced SAS device. As noted above, such OOB signals that may be digitally encoded for use, in particular, on an optical transmission medium. The digitally encoded OOB signals may include, for example, COMINIT, COMSAS, COMWAKE, etc. De-scrambling may be optionally performed depending on where the decoding of digitally encoded OOB signals takes place within the SAS device. For example, scrambled dwords may be de-scrambled before a decision is made that a received dword represents a digitally encoded OOB signal. Alternatively, scrambled dwords may be presented to the logic responsible for decoding of digitally encoded OOB signals such that the decoder may integrate the de-scrambling with the function of decoding to determine whether a dword represents a digitally encoded OOB signal. These and other embodiments will be apparent to those of ordinary skill in the art as a matter of design choice in the design of the enhanced SAS device logic.

The exemplary method of FIG. 4 represents processing within the enhanced high speed device for generating and transmitting an OOB signal as an appropriately encoded digital OOB signal for transmission on, for example, an optical communication medium (or optionally on an electrical communication medium also generally capable of standard analog OOB communications).

Step 400 represents processing to generate an OOB signal intended for transmission to another device. The OOB signal is initially generated as an analog signal typically in the PHY logic of the generated high speed device. Step 402 then encodes and (optionally) scrambles the generated SAS OOB signal as a digitally encoded OOB signal for transmission over a communication medium (e.g., an optical or electrical communication medium). Step 404 then transmits the digitally encoded signal to the other high speed device. As noted herein, the encoding of a particular OOB signal is defined in SAS/SATA standards by the duration and number of alternating idle and burst conditions. Thus the digital encoding of such OOB signals may generally entail transmitting digitally encoded idle and burst dwords to the other device so as to indicate a corresponding idle and burst condition for the designated durations for encoding of a particular OOB signal. The other device, similarly enhanced, receives such a digitally encoded OOB signal and decodes the intended OOB signal for further processing as discussed above with respect to FIG. 3. Scrambling of the digitally encoded OOB signal dwords is optional as discussed above with respect to FIG. 3 as a matter of design choice. The scrambling logic (like the de-scrambling logic discussed above in FIG. 3) may be integrated with the logic that digitally encodes OOB signals or may be performed in other logic associated with the enhanced SAS device.

Those of ordinary skill in the art will readily recognize numerous additional and equivalent steps that may be present in fully functional methods for receiving digitally encoded OOB signals and for generating and transmitting OOB signals as digitally encoded signals. Such additional and equivalent steps are omitted herein for simplicity and brevity of this discussion but will be otherwise readily apparent to those of ordinary skill in the art.

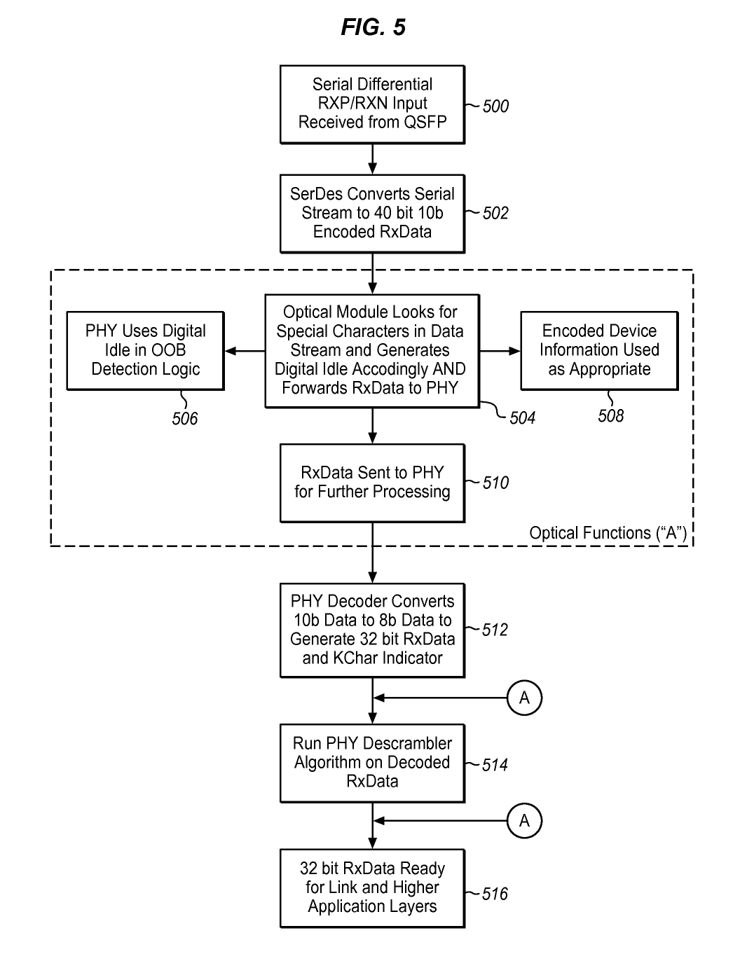

FIG. 5 is a flowchart describing another exemplary method in accordance with features and aspects hereof. The exemplary method of FIG. 5 describes a method for receiving digitally encoded signals representing SAS OOB conditions exchanged between enhanced SAS devices in accordance with features and aspects hereof. The method of FIG. 5 may be performed and integrated within enhanced SAS devices such as described above with respect to FIGS. 1 and 2.

Step 500 represents receipt from the SFP/QSFP optical module of a digitally encoded signal on the SAS communication medium. The signal is received on the electrical, differential receive signal paths (e.g., RXP and RXN) of the physical layer logic of the SAS device. Step 502 represents processing by the SerDes of the SAS device to convert the differential electrical signals into a 40 bit 10 bit encoded dword (i.e., a dword encoded in the SAS standard 8b10b encoding).

Steps 504, 506, 508, and 510 represent processing by the optical processing function of the enhanced SAS device (i.e., logic associated with processing of digitally encoded OOB signals). Step 504 determines whether the digitally encoded dword just received represents a “special character” used in the digitally encoded SAS OOB signaling (i.e., a digitally encoded Idle dword or a digitally encoded Burst dword). If step 504 recognizes the received dword as a digitally encoded Idle or Burst dword the Digital Idle signal is adjusted accordingly (asserted or de-asserted depending on the digitally encoded Idle/Burst dword detected). Step 506 represents processing within the PHY logic of the SAS device to process an OOB signal in accordance with the Digital Idle signal as presently generated by step 504. In addition, if step 504 recognizes receipt of a digitally encoded Idle/Burst dword, step 508 represents processing within the SAS device to extract information regarding the transmitting device from the received digitally encoded Idle/Burst dword. As noted above, the digitally encoded Idle/Burst dwords representing the digitally encoded OOB signals may also encode information regarding characteristics of the transmitting device such as supported speeds, compatibility level, and vendor-specific information. Step 510 next passes the received dword to the PHY logic for further processing of a received SAS dword. As discussed further herein below, these optical functions (steps 504, 506, 508, and 510) may be performed at other points in the method of FIG. 5. These “optical functions” are collectively referred to herein below by the label “A”.

Step 512 represents processing by the PHY logic to decode the 10 bit encoded dword into a 32 bit dword represented as a KChar indicator (as described in the SAS standards). In one alternative embodiment, the optical functions “A” described above, may be performed after the processing of this step 512 to convert the bit encoded dword into a corresponding 8 bit encoded dword.

Following processing of step 512 (and optionally the optical functions “A”), step 514 represents processing of de-scrambling logic in the PHY logic to de-scramble the received dword. In another alternative embodiment, optical functions “A” described above may be performed following the de-scrambling function of step 514.

Lastly, step 516 transfers the processed 32 bit dword to the Link layer logic and thence to higher application related layers of the SAS protocol stack.

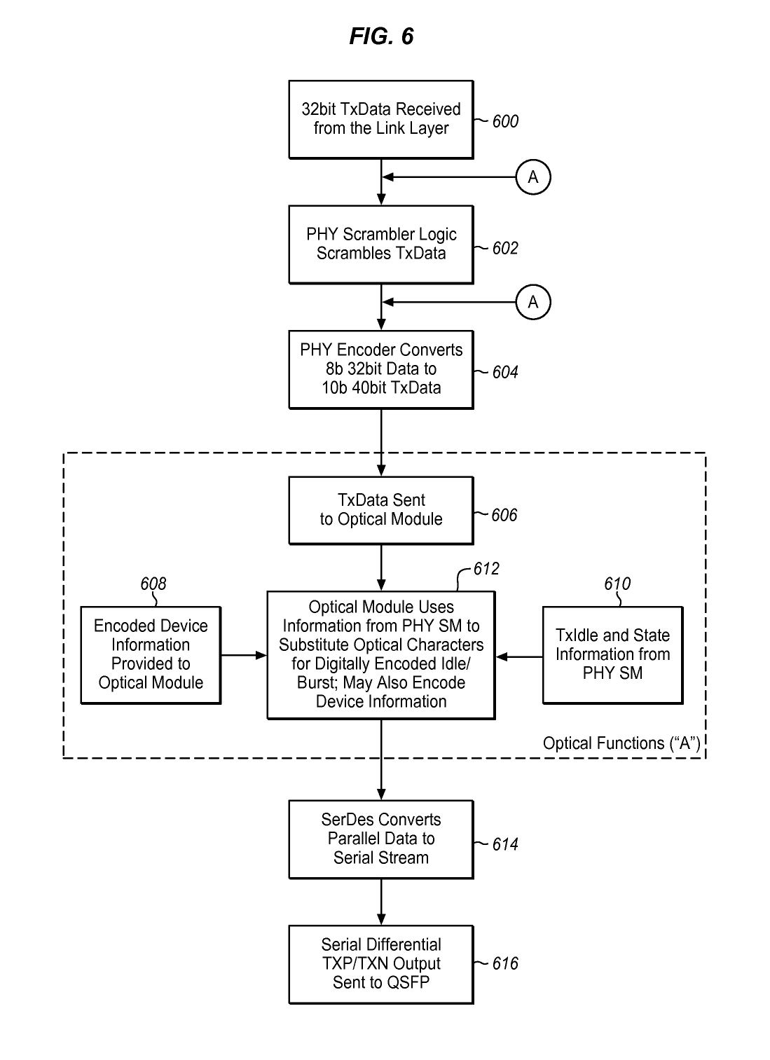

FIG. 6 is a flowchart describing another exemplary method in accordance with features and aspects hereof wherein an enhanced SAS device encodes a generated SAS OOB signal into corresponding digitally encoded information for transmission over a SAS communication medium (e.g., over an optical communication medium). The method of FIG. 6 may be performed within enhanced SAS devices such as described above with respect to FIGS. 1 and 2.

The method of FIG. 6 represents processing by enhanced circuits coupled with, and/or integrated with, the PHY logic of the SAS device. The enhanced circuits and hence the method of FIG. 6 are engaged when the PHY logic indicates a need to send a SAS OOB signal to the other SAS device and the digital OOB mode has been enabled by configuration of the transmitting SAS device.

Step 600 represents receipt of a 32 bit (8 bit encoded) dword from an associated Link logic layer. Step 602 then represents processing of scrambling logic of the PHY logic layer to scramble a sequence of transmitted dwords as defined in the SAS standards. Step 604 then encodes the scrambled 32 bit dword into a 40 bit, 10 bit encoded dword (i.e., in accordance with 8b10b encoding standards of the SAS standards).

Steps 606, 608, 610, and 612 represent optical processing functions within the enhanced SAS device to generate digitally encoded SAS OOB signals for transmission over optical (or electrical) communication media. Step 606 represents forwarding of the scrambled, encoded dword to the optical functions (labeled “A”). If signals from the PHY state machine generated in step 610 indicate that a SAS OOB signal is to be sent, step 612 generates a digitally encoded Idle/Burst dword to represent the desired SAS OOB signal indicated by the information provided from step 610. In addition, step 608 may provide information regarding the SAS device to be encoded in the digitally encoded Idle/Burst dwords representing the SAS OOB signal. Such information, if provided by step 608, is also encoded in the digitally encoded Idle/Burst dwords of the digitally encoded SAS OOB signals. If no digitally encoded OOB signal is required (as indicated to step 612 by state information in step 610), then the scrambled, encoded dword provided in step 606 is forwarded on from step 612 for further processing in the SerDes and/or PHY logic layers. If step 612 generated a digitally encoded Idle/Burst dword, that generated dword is forwarded from step 612 for further processing in the SerDes and/or PHY logic layer of the SAS device.

In step 614, the dword received from step 612 is converted to a serial data stream by SerDes logic of the SAS device. This serial stream is then applied to the electrical differential outputs (i.e., TXP and TXN) of the SAS device which is, in turn, applied as inputs to the SFP/QSFP for application to the optical communication medium.

In alternative embodiments, the optical functions (labeled “A”) may be performed between steps 600 and 602 (i.e., before scrambling logic is applied) or between steps 602 and 604 (i.e., after scrambling but before encoding as a 10-bit dword). Additional and equivalent steps have been omitted from the flowcharts of FIGS. 5 and 6 for brevity and simplicity of this discussion. Such additional and equivalent steps will be readily apparent to those of ordinary skill in the art. Further, those of ordinary skill in the art will readily recognize that the methods of FIGS. 3 through 6 may be implemented as suitably programmed instructions in a general or special purpose processor within the enhanced SAS device, may be implemented as custom designed logic circuits within the enhanced SAS device, or may be implemented as a combination of custom logic circuits and suitably programmed instructions operable on a general or special purpose processor. Such design choices will be readily apparent to those of ordinary skill in the art.

Alternative embodiments of the invention may alter the requirements of the SAS specifications as they relate to use of such OOB signals. In general, OOB signals are used in the SAS specification to initially establish a connection between two coupled devices. The OOB signals (idle and burst periods) are used to exchange information regarding the maximum speeds supported by both devices and to then negotiate a commonly supported speed and to train at that selected speed.

In one alternative embodiment, upon detection of a physical connection through an optical cable (using an SFP/QSFP module), the devices could be altered to move directly to a training sequence at a mutually supported speed. The “Los” signal indicator in the SFP/QSFP module (a standard signal of such modules indicating detection of a connected cable with another module) could be used to indicate that a physical connection has been made between the two devices. I²C/GPIO signals could be used to forward this status to the SAS devices coupled through the SFP/QSFP modules. Once this is sensed in the SAS logic components of the two SAS devices, the SAS logic of the two devices could jump directly to training at the maximum supported rate of the SFP/QSFP modules. Based on a timeout awaiting Training Done primitives, the two SAS devices could then drop to the next lower speed and wait again (with a timeout) for the Training Done primitives to be received. This would continue until a connection could be established. Once this occurs, the normal SAS process of passing inquiry data could then occur.

Most SFP/QSFP modules contain EEPROM (or other non-volatile memory components) accessible through I²C/GPIO signals. This memory contains data on the maximum speed supported by the SFP/QSFP module. Also contained in this memory is a section where an application (i.e., the SAS device) can write additional data. The SAS devices could use the specified maximum speed to determine a starting point for the speed to be supported or could specify the only speed to be used with the SFP/QSFP and color-code the SFP/QSFP modules to indicate the only supported speed. Where a maximum starting speed or multiple speeds are specified, the application could also program in the SFP/QSFP memory the order in which to “fall back” for a lower speed if necessary. A user configuring the system then need only visually match up the color-coded SFP/QSFP modules when coupling SAS devices using the modified modules.

In this alternative embodiment, breaking a connection would require turning the laser off. This will cause the receiving SFP/QSFP module to indicate the cable has been removed and I²C/GPIO signals would cause the receiving SAS device to drop the link and wait for the cable to be reconnected to start over. The sending device would re-enable the SFP/QSFP laser. One millisecond later, when the laser is again turned on, the process starts over again.

In another alternative embodiment, the timing and timeouts relating to OOB signaling as specified in the SAS standards may be extended to allow for the slower on/off times of the lasers in SFP/QSFP modules. If all the OOB related timings and timeouts are increased when the presence of an SFP/QSFP module is detected then there is no change required to the logic in the SAS devices that implements the SAS protocol (other than longer timers/counters). This embodiment slows down the initial connection between pairs of SAS devices but these initial connections typically occur at start of day “boot up” and thus do not impose a significant performance loss.

In a third alternative embodiment, the SAS specifications for speed negotiation may be altered in a manner similar to features of the Fibre Channel protocols. In this alteration, the SAS devices can enter speed negotiation with Align (0). Once both SAS devices recognize the Aligns they both transition from Align (0) to Align (1) to indicate both sides are linked. Once the Align (1) signals are exchanged, the Align (1) is changed to a D10.X dword to indicate the transmitting SAS device's maximum supported speed. For example, D10.1 indicates 1.5 Gbps, D10.2 indicates 3 Gbps, and D10.3 indicates 6 Gbps. For example, if a first SAS device is capable of 6 Gbps operation and receives a D10.2 dword from a second SAS device, then the first SAS device can switch to a maximum speed of 3 Gbps (and change its D10.3 signals to D10.2). When both SAS devices are sending and receiving the same D10.X dwords then they have agreed on the maximum commonly supported data rate. At this point the SAS devices may go directly to a training state or a PHY ready state and continue normal processing.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. Apparatus associated with a first high speed serial device for coupling with another high speed serial device using an optical communication medium or using an electrical communication medium wherein both the first and second high speed serial devices are either Serial Attached SCSI (SAS) devices or Serial Advanced Technology Attachment (SATA) devices, the apparatus comprising:
PHY control circuits coupled with a communication interface and adapted to control data exchanges on the communication medium;
digital out of band (OOB) encoder/decoder (endec) logic coupled with the PHY control circuits and coupled with the communication medium, the digital OOB endec logic adapted to translate between OOB signals utilized by the PHY control circuits and digitally encoded OOB signals utilized on the communication medium; and
scrambling logic coupled with the digital OOB endec to de-scramble digitally encoded OOB signals received from the communication medium and to scramble generated digitally encoded OOB signals generated by the digital OOB endec for application to the communication medium.

2. The apparatus of claim 1
wherein the communication medium is either one of an optical communication medium or an electrical communication medium.

3. The apparatus of claim 1 further comprising:
programmable memory coupled with the digital OOB endec and operable to store digitally encoded signals for use by the digital OOB endec to generate the digitally encoded OOB signals and for use by the digital OOB endec to decode received digitally encoded OOB signals,
wherein the digitally encoded signals comprise a digitally encoded idle dword and a digitally encoded burst dword, and
wherein the programmable memory stores the digitally encoded signals in both a negative disparity format and in a positive disparity format.

4. The apparatus of claim 1
wherein the digital OOB endec is integral with the PHY control circuits.

5. The apparatus of claim 1
wherein the digital OOB endec is external from the PHY control circuits and adapted to couple with the PHY control circuits using one or more of a General Purpose I/O (GPIO) signal path of the PHY control circuits or an Inter IC (I²C) communication bus structure of the PHY control circuits.

6. The apparatus of claim 5
wherein the digital OOB endec is integral with a cable, the PHY control logic adapted to couple with the cable.

7. The apparatus of claim 1
wherein the digitally encoded OOB signal comprises information regarding the high speed serial device that generated the digitally encoded OOB signal.

8. The apparatus of claim 7
wherein the indicia of capability comprises dwords interspersed between an idle dword and a burst dword.

9. The apparatus of claim 7
wherein the information regarding the high speed serial device comprises indicia of capability of the high speed serial device, the indicia including one or more of:
SAS generation 1 compatibility (supporting 1.5 and 3.0 Gbps),
SAS generation 2 compatibility (supporting 1.5, 3.0, and 6.0 Gbps),
SAS generation 3 compatibility (supporting 1.5, 3.0, 6.0, and 12.0 Gbps),
Serial Advanced Technology Attachment (SATA) compatibility,
vendor specific protocol compatibility, or
vendor specific device identification indicia.

10. The apparatus of claim 9
wherein the indicia of capability comprises dwords interspersed between an idle dword and a burst dword.

11. A method operable in a system that comprises apparatus associated with a high speed serial device wherein the high speed serial device is either a Serial Attached SCSI (SAS) device or a Serial Advanced Technology Attachment (SATA) device, the method comprising:
receiving over a communication medium coupled with the apparatus a digitally encoded signal from another high speed serial device;
decoding, within the apparatus, the received descrambled digitally encoded signal to generate a signal representing an incoming out of band (OOB) signal;
applying the generated signal to a PHY logic circuit within the high speed serial device; and
processing, within the high speed serial device, the generated signal as though the incoming OOB signal had been received in the PHY logic circuit from the communication medium.

12. The method of claim 11
wherein the digitally encoded signal comprises information regarding said another high speed serial device, the method further comprising:
using the information regarding said another high speed serial device in establishing a connection between the high speed serial device and said another high speed serial device.

13. The method of claim 12
wherein the information regarding said another high speed serial device comprises indicia of capability of said another high speed serial device, the indicia including one or more of:
SAS generation 1 compatibility (supporting 1.5 and 3.0 Gbps),
SAS generation 2 compatibility (supporting 1.5, 3.0, and 6.0 Gbps),
SAS generation 3 compatibility (supporting 1.5, 3.0, 6.0, and 12.0 Gbps),
Serial Advanced Technology Attachment (SATA) compatibility,
vendor specific protocol compatibility, or
vendor specific device identification indicia.

14. The method of claim 11 further comprising:
generating an outgoing OOB signal within the high speed serial device to be forwarded to said another high speed serial device;
applying the outgoing OOB signal to the apparatus;
encoding, within the apparatus, the OOB signal as an outgoing digitally encoded signal; and
transmitting the scrambled outgoing digitally encoded signal from the apparatus over said communication medium to said another high speed serial device.

15. The method of claim 14
wherein the outgoing digitally encoded signal comprises indicia of capability of the high speed serial device, the indicia including one or more of:
SAS generation 1 compatibility (supporting 1.5 and 3.0 Gbps),
SAS generation 2 compatibility (supporting 1.5, 3.0, and 6.0 Gbps),
SAS generation 3 compatibility (supporting 1.5, 3.0, 6.0, and 12.0 Gbps),
Serial Advanced Technology Attachment (SATA) compatibility,
vendor specific protocol compatibility, or
vendor specific device identification indicia.

16. A system comprising:
a first high speed serial device;
a second high speed serial device, wherein both the first and second high speed devices are either Serial Attached SCSI (SAS) devices or Serial Advanced Technology Attachment (SATA) devices;
a communication medium coupled the first high speed serial device with the second high speed serial device;
a first digital out of band (OOB) encoder/decoder (endec) logic coupled with the first high speed serial device and coupled with the communication medium, the first digital OOB endec logic adapted to translate between OOB signals utilized by the first SAS device and digitally encoded OOB signals utilized on the communication medium;
a first scrambling logic coupled with the first digital OOB endec, the first scrambling logic operable to de-scramble digitally encoded OOB signals received from the communication medium and further operable to scramble digitally encoded OOB signals generated by the first digital OOB endec for application to the communication medium;
a second digital out of band (OOB) encoder/decoder (endec) logic coupled with the second high speed serial device and coupled with the communication medium, the second digital OOB endec logic adapted to translate between OOB signals utilized by the second high speed serial device and digitally encoded OOB signals utilized on the communication medium; and
a second scrambling logic coupled with the second digital OOB endec, the second scrambling logic operable to de-scramble digitally encoded OOB signals received from the communication medium and further operable to scramble digitally encoded OOB signals generated by the second digital OOB endec for application to the communication medium.

17. The system of claim 16
wherein the first digital OOB endec logic and the first scrambling logic are integral with the first high speed serial device; and
wherein the second digital OOB endec logic and the second scrambling logic are integral with the second high speed serial device.

18. The system of claim 16
wherein the first digital OOB endec logic and the first scrambling logic are integral with the cable comprising the communication medium; and
wherein the second digital OOB endec logic and the second scrambling logic are integral with the cable.
